(19) United States
(12) Patent Application Publication
(10) Pub. No.: US 2009/0319778 A1
(43) Pub. Date: Dec. 24, 2009

(54) User authentication system and method without password

(76) Inventors: Pawel Rzepecki, Krakow (PL); Jurzyk Andrzej, Krakow (PL); Thomas Majcher, Los Angeles, CA (US); Rum M. Wojciech, Stamford, VT (US)

Correspondence Address: Richard B. Klar;Law Office of Richard B. Klar, Suite #6, 145 Willis Avenue,, Mineola, NY, 11501, US

(21) Appl. No.: 12/386,827

(22) Filed: Apr. 23, 2009

Related U.S. Application Data
(60) Provisional application No. 61/125,442, filed on Apr. 25, 2008.

(51) Int. Cl. H04L 9/32

(52) U.S. Cl. 713/155; 726/3; 713/176

(57) ABSTRACT

A Verified unit (VU) communicates with an Authenticating Unit (AU). The VU only provides the AU with the user's public key via RSA technology known in the art. The AU sends a character string to the VU requiring the VU to generate a digital signature which is sent to an Authority server (AS) to authenticate the digital signature information provided to the AU by the VU. If the AS authenticates the information it informs the AU and the AU will provide the VU's requested data to the VU.

This is a non-provisional application of a provisional application Ser. No. 61/25,442 by Pawel Rzepecki, et al. filed Apr. 25, 2008.

### BACKGROUND

The present disclosure relates to a method and system for providing user authentication without the need for transmission of a user's password. In particular the present disclosure provides for an end point to endpoint method and system in a multipoint network for a user to request and access to data at another endpoint without needing to provide the user's private password maintained at the user's endpoint site.

Today to access data from another endpoint such as a remote computer terminal through wireless or online communications it is necessary for a user to provide the user's private password which is input and/or located on the user's endpoint computer. The transmission of this information can be detected by computer hackers and the user's security can be compromised. It therefore would be desirable to provide for endpoint to endpoint network where the user does not need to transmit the user's private password or private key which can be retained at the user's site such as the user's computer while still providing verification to the user's identity and access to the user's requested data at the remote location endpoint.

### SUMMARY

The present disclosure relates to a method and system that permits a user at his endpoint station computer-Verified Unit (VU) to communicate with another endpoint such as a computer—the Authenticating Unit (AU). The VU only provides the AU with the user's public key via RSA technology known in the art. The AU will send a character string to the VU requiring the VU to generate a digital signature which is sent to the third endpoint—the Authority server (SAAS) to authenticate the digital signature information provided to the AU by the VU. If the AS authenticates the information it informs the AU and the AU will provide the VU's requested data to the VU.

### BRIEF DESCRIPTION OF THE DRAWINGS

FIG. 1 is a block diagram showing the method and the system of the present disclosure;

FIG. 2 is a detailed block diagram of the method and the system of the present disclosure; and

FIG. 3 is a flow chart showing the operation of the method and the system of the present disclosure.

### DETAILED DESCRIPTION OF THE PREFERRED EMBODIMENT(S)

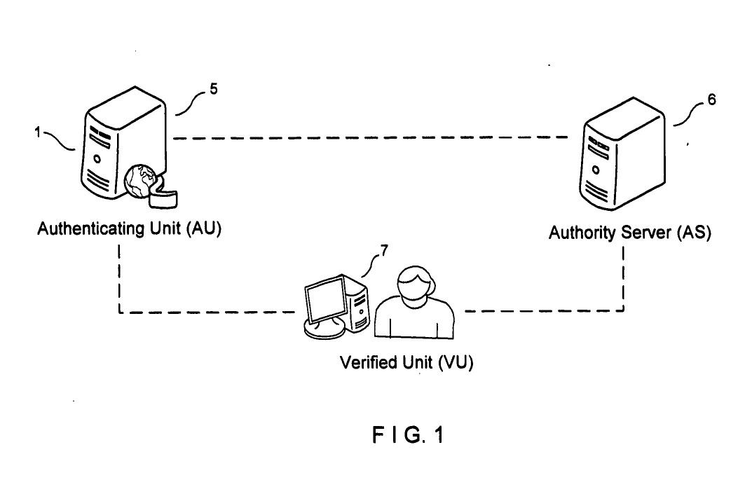

Referring to the drawings, FIG. 1 illustrates a general block diagram of the method and the system of the present disclosure in which three endpoints are networked together. The three endpoints include: a Verified Unit 7 (VU); an Authenticating Unit 5 (AU) and an Authority Server 6 (AS).

The AU 5 can be any software package, server or information content provider such as Web services. The AS 6 can be a physical server machine providing a user's public key for purposes of authentication. The VU 7 can be any user physical computer or service requesting authorized service of an AU 5. It is understood that the present disclosure is not limited to a three endpoint system or method but can be used for or include a multipoint endpoints system or method as desired or required.

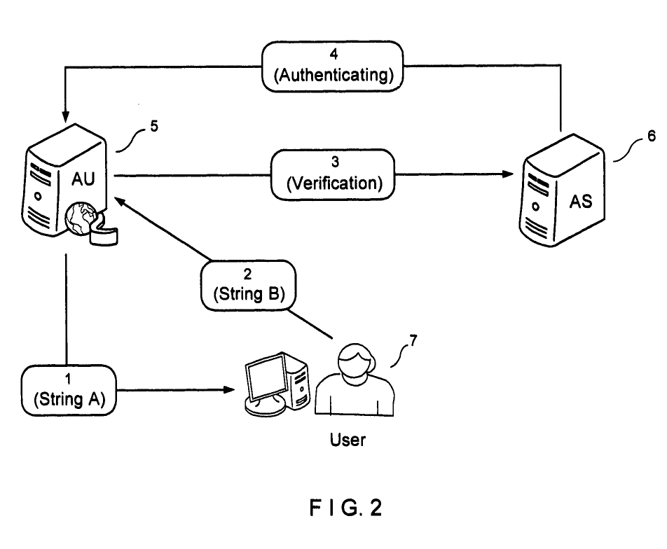

FIG. 2 shows a detailed block diagram of the present disclosure. The VU 7 seeks access to data on the AU 5. In order to conduct an authentication process, the VU must first generate a pair of asymmetric RSA encryption keys. The public key is sent over to the AS 6 while the private key is maintained on the VU 7. During the authentication process, both keys are used to exchange confidential information between the AU 5 and the VU 7. The authentication process starts with the AU 5 generating a random string of characters for every query submitted by the VU 7. This string is also automatically stored at the AU 5 for future verification of data. The VU 7 then acquires the string of characters from the AU 5 and adds the digital signature by the private key on the VU 7 in asymmetric encryption.

At the same time, the VU 7 adds its unique name e.g. user name, by which the AU 5 can verify the identity of the data. The information containing the digital signature of the string received from the AU 5 and the name of the VU 7 is then sent to the AU 5. When the AU 5 receives this information from the VU 7, the AU 5 checks the validity of the digital signature. If the AU 5 does not have the public key, it retrieves it from the AS in order to conduct that verification. When the information from the VU 7 is verified by the AU 5 as being the same as the one generated by the AU 5 and the digital signature is verified by the public key, the identity of the VU 7 is authenticated and the requested data in the AU 5 is sent to the VU 7.

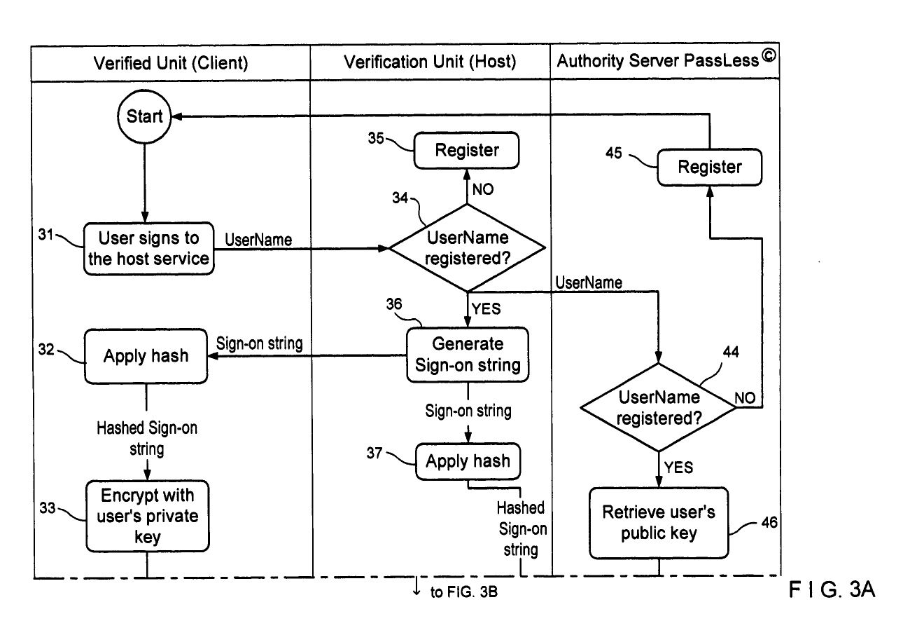

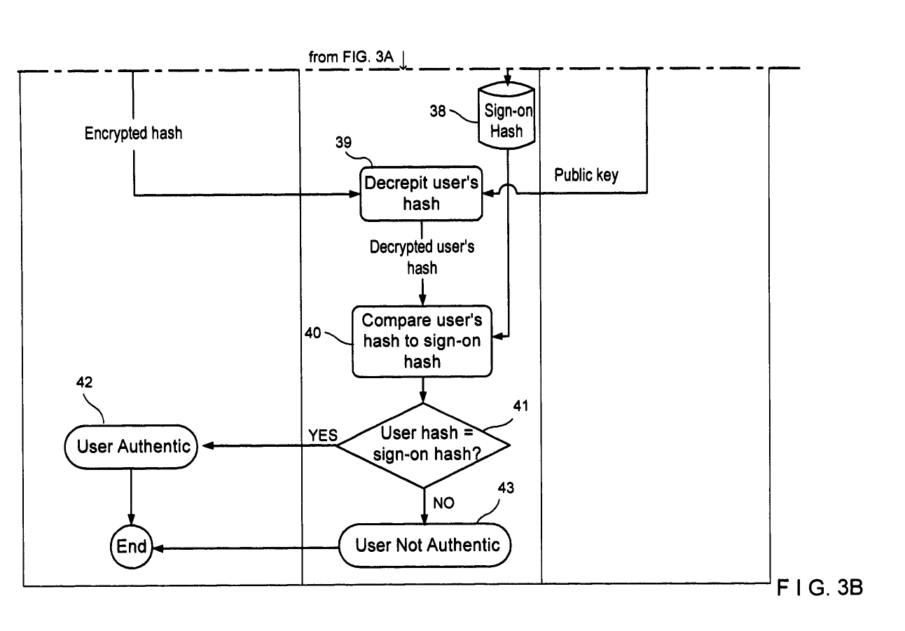

FIG. 3 is an operational flow chart of the system and method of the presented disclosure. It shows each step and in vertical columns indicates which step is being performed by the verified unit VU 7, the verification unit AU 5 and the authenticating server AS 6. As can be seen in FIG. 3 then the VU 7 user signs in to the AU 7 where the AU checks to see if the user is registered 34. The AU can check with the AS to see if the name—user name is registered and if it is, the public key is retrieved and sent to the AU for use in step 39 for decrypting the user's hash. If the user is registered a sign on string is generated (string A of FIG. 2). The VU hash is applied to the string where hash is a hash function and is any well-defined procedure or mathematical function for turning some kind of data into a relatively small integer, that may serve as an index into an array. The values returned by a hash function are called hash values, hash codes, hash sums, or simply hashes (step 32). The hashed string is then encrypted at user VU 7 with the user's private key and sent to the AU. In step 37 hash is also applied to the string that was sent to the VU 7 and held in step 38 as a sign on hash which is compared to the user's hash after being decrypted in step 39 at step 40. If the user's hash is the same as the sign on hash then the user is authenticated and the requested data is proved to the VU 7 by the AU 5.

The system and the method of the present disclosure have numerous applications including but not limited to the following non-limiting illustrative examples:

A user may wish to contact via the internet his bank's web site to check his account balance in his check book account. User inputs his user name and provides only his public key via RSA technology that is known in the art. The bank computer (AU) will ask him for a character string that will require his computer (VU) to generate a digital signature which is then sent by the AU to the AS (authority server) which if the AS authenticated the information provided by the user, the AU will provide the data requested by the VU 7 e.g. the balance account information in the user's check book. A user thus only need to provide his user name and not his password, e.g. private key. His password or private key is only necessary for his own computer VU which has the RDS technology to generate the digital signature on request which can be authenticated by the system of the present disclosure. Other applications can include anything from permitting a door of a garage to open automatically or a security alarm mode to be set or removed as necessary.

While presently preferred embodiments have been described for purposes of the disclosure, numerous changes in the arrangement of method steps and apparatus parts can be made by those skilled in the art. Such changes are encompassed within the spirit of the invention as defined by the appended claims.

1. A password free user authentication system, comprising:
a verified unit (VU) for communication between a user and an authenticating unit (AU), said verified unit communicating and requesting information from said AU by a user's public key via RSA technology;
said AU generating a character string in response to said public key sent from said VU said character string requesting said VU to generate a digital signature; and
an authority server (AS) for authenticating the generated digital signature and informing said AU so that AU will provide the requested information to the VU.

2. The system according to claim 1 wherein said AU can be any end point.

3. A method for providing password free user authentication, the steps comprising:
a verified unit (VU) for communicating between a user from a verified unit (VU) and an authenticating unit (AU),
communicating and requesting information by said verified unit from said AU via a user's public key via RSA technology; and
generating a character string by said AU in response to said public key sent from said VU, said character string requesting said VU to generate a digital signature; and
for authenticating the generated digital signature by an Authority server (AS) and then said AU informing as to the authenticity of the digital signature said AU so that AU will provide the requested information to the VU.

4. The method according to claim 3 wherein said AU can be any end point.
